(19) United States
(12) Patent Application Publication
(10) Pub. No.: US 2025/0334406 A1
(43) Pub. Date: Oct. 30, 2025

(54) LEVEL

(71) Applicant: Emily Parish, Holly Springs, NC (US)

(72) Inventor: Emily Parish, Holly Springs, NC (US)

(21) Appl. No.: 19/189,698

(22) Filed: Apr. 25, 2025

Related U.S. Application Data
(60) Provisional application No. 63/639,204, filed on Apr. 26, 2024.

(51) Int. Cl. G01C 9/34; G01C 9/28; G01C 15/10

(52) U.S. Cl. CPC G01C 9/34; G01C 9/28; G01C 15/105

(57) ABSTRACT

A level for hanging objects designed to receive one or more marks from a writing utensil. The level includes a plurality of edges, a leveling component, a slit, and a writing surface. The leveling component indicates an orientation of the level (e.g., horizontal, vertical). The writing surface receives marks from the writing utensil and is designed for the received marks to be removed (e.g., erasure).

### CROSS-REFERENCE TO RELATED APPLICATIONS

This application claims the benefit and priority to U.S. Provisional Patent Application No. 63/639,204, filed on Apr. 26, 2024, the entire content of which is incorporated by reference herein in its entirety.

### BACKGROUND

Current tools and methods for hanging objects (e.g., pictures) include (1) using a ruler or measuring tape to draw straight lines between target points, (2) placing nail/screws in a wall, (3) eyeballing a height, distance, and level of an object, (4) using tape, paper, or string to measure distance, (5) using a laser, and (6) measuring similar sized objects (e.g. paper) and creating holes to indicate a hanging component on the frame. These tools and methods can be inefficient, inaccurate, and/or expensive. Further, these tools and methods can require a second individual to ensure that an object is level.

### FIELD OF THE PRESENT DISCLOSURE

The present disclosure is generally related to levels, more specifically to levels for receiving marks to improve the hanging of articles.

### DESCRIPTION OF RELATED ART

Existing levels can cause problems for construction workers, do-it-yourself (DIY) individuals, homeowners, and other individuals that hang objects. These levels can be cumbersome and inaccurate, thereby resulting in unleveled objects. This is detrimental to the appearance of buildings, walls, and other structures. Further, some levels can require multiple users to successfully measure distances while hanging an object. Yet another problem with current levels is that users must rely on their memory and a steady hand to make a mark for nail holes. Therefore, there is a need for a level that enables a user to easily and successfully hang objects without the use of a second individual.

### BRIEF SUMMARY

In some embodiments, a tool including a flat surface with a leveling device, a plurality of edges, a writing surface, and at least one slit is disclosed. The plurality of edges enables the level to stand without an additional tool or device. The writing surface is designed to receive a mark from a marking tool (e.g., pen) to improve a user's accuracy when hanging an object. The at least one slit enables the marking tool to reach and mark a target surface for an object.

In some embodiments, the tool is a level including at least one u-shaped slit. The tool includes a leveling device and a plurality of measurement markers. For example, and without limitation, the plurality of measurement markers includes millimeters increments. The level includes a writing surface for receiving a mark from a marking tool. The writing surface is further designed for the mark to be removed (e.g., erased).

The level is an improvement over existing tools because the slit in the material and the ability to make a pencil mark and erase the pencil mark on the writing surface. The slit provides enough space to make a mark and greatly reduces the opportunity for error.

In some embodiments, the level includes plastic, metal, composite, and/or a combination thereof. In some other embodiments, the level includes a second leveling component in a vertical position. In some embodiments, the level includes a holder for a writing utensil/marking tool. In some embodiments, the level includes a visual marker. For example, and without limitation, the visual marker includes a laser. In some embodiments, the level includes a magnetic component to attach to a wall or another object. In some embodiments, the level includes at least one sensor. For example, and without limitation, the at least one sensor includes an imaging sensor (e.g., camera) and is operable to detect the presence and location of a hanging component of an article. The level further includes an audio component designed to give audio cues to aid with placing an article on the wall.

In at least one aspect of the present disclosure, a level is disclosed. The level can include at least one leveling component, a plurality of edges, at least one slit, and at least one writing surface. The at least one leveling component can indicate a horizontal orientation of the level. The at least one slit can provide access to a hanging surface. The writing surface can receive a mark from a writing utensil. The writing surface can further allow for removal of a mark from a writing utensil.

In at least one aspect of the present disclosure, the at least one leveling component can include at least two leveling components. At least one leveling component can indicate a horizontal orientation of the level. At least one leveling component can indicate a vertical orientation of the level. In at least one aspect of the present disclosure, the at least one writing surface includes a vertical writing surface and a horizontal writing surface. In at least one aspect of the present disclosure, the writing utensil is slidably connected to the level. In at least one aspect of the present disclosure, the writing surface and the at least one leveling component are positioned between the plurality of edges. The plurality of edges runs along a top and a bottom of the level. In at least one aspect of the present disclosure, each edge of the plurality of edges extends away from the at least one writing surface. In at least one aspect of the present disclosure, the level can further include at least one visual identification tool. The at least one visual identification tool can include a laser and/or a sensor. In at least one aspect of the present disclosure, the level can further include at least one magnet. The level can attach to a wall or object utilizing the at least one magnet. In at least one aspect of the present disclosure, the writing surface may include at least one of an enamel, epoxy, laminate film, paint, plastic, or tape.

In at least one aspect of the present disclosure, a level is disclosed. The level can include a plurality of leveling components, a plurality of edges, a plurality of slits, and at least one writing surface. The plurality of leveling components can indicate an orientation of the level. The at least one writing surface is positioned between the plurality of edges. The plurality of slits can allow at least a portion of a writing tool to pass through the plurality of slits. The at least one writing surface can receive a mark from a writing utensil.

In at least one aspect of the present disclosure, the plurality of leveling components includes a horizontal leveling component and a vertical leveling component. The horizontal leveling component can indicate a horizontal orientation of the level. The vertical leveling component can indicate a vertical orientation of the level. In at least one aspect of the present disclosure, the plurality of edges runs along a top and a bottom of the level. In at least one aspect of the present disclosure, the level includes at least one visual identification tool. The at least one visual identification tool can include a laser and/or a sensor. In at least one aspect of the present disclosure, the at least one writing surface can include at least one of an enamel, epoxy, laminate film, paint, plastic, or tape.

In at least one aspect of the present disclosure a level is disclosed. The level can include a plurality of leveling components, a plurality of edges, a plurality of slits, and at least one writing surface. The plurality of leveling components includes a horizontal leveling component and a vertical leveling component. The horizontal leveling component can indicate a horizontal orientation of the level. The vertical leveling component can indicate a vertical orientation of the level. The at least one writing surface can be positioned between the plurality of edges. Each edge of the plurality of edges can extend away from the at least one writing surface. The plurality of slits can enable at least a portion of a writing tool to pass through the plurality of slits to a hanging surface. The at least one writing surface can receive a mark from a writing utensil.

In at least one aspect of the present disclosure, the plurality of slits can include at least two slits. In at least one aspect of the present disclosure, the writing utensil is slidably connected to the level. In at least one aspect of the present disclosure, the mark is removable from the at least one writing surface. In at least one aspect of the present disclosure, the level can further include at least one visual identification tool. The at least one visual identification tool can include a laser and/or a sensor.

### BRIEF DESCRIPTION OF THE DRAWINGS

The embodiments illustrated, described, and discussed herein are illustrative of the present disclosure. As these embodiments of the present disclosure are described with reference to illustrations, various modifications, or adaptations of the methods and or specific structures described may become apparent to those skilled in the art. It will be appreciated that modifications and variations are covered by the above teachings and within the scope of the appended claims without departing from the spirit and intended scope thereof. All such modifications, adaptations, or variations that rely upon the teachings of the present disclosure, and through which these teachings have advanced the art, are considered to be within the spirit and scope of the present disclosure. Hence, these descriptions and drawings should not be considered in a limiting sense, as it is understood that the present disclosure is in no way limited to only the embodiments illustrated.

FIG. 1A illustrates a front perspective view of a level according to one embodiment of the present disclosure.

FIG. 1B illustrates a front view of the level as shown in FIG. 1A.

FIG. 1C illustrates a side view of a level as shown in FIG. 1A.

FIG. 1D illustrates a side view of a level as shown in FIG. 1A.

### DETAILED DESCRIPTION

For the purpose of promoting an understanding of the present disclosure, reference will be made to preferred embodiments and specific language will be used to describe the same. It will nevertheless be understood that no limitation of the scope of the disclosure is thereby intended, such alteration and further modifications of the disclosure as illustrated herein, being contemplated as would normally occur to one skilled in the art to which the disclosure relates.

Articles “a” and “an” are used herein to refer to one or to more than one (i.e., at least one) of the grammatical object of the article. By way of example, “a composite” means at least one composite and can include more than one composite.

Throughout the specification, the terms “about” and/or “approximately” may be used in conjunction with numerical values and/or ranges. The term “about” is understood to mean those values near to a recited value. For example, “about 40 [units]” may mean within +/−25% of 40 (e.g., from 30 to 50), within +/−20%, +/−15%, +/−10%, +/−9%, +/−8%, +/−7%, +/−6%, +/−5%, +/−4%, +/−3%, +/−2%, +/−1%, less than +/−1%, or any other value or range of values therein or there below. Furthermore, the phrases “less than about [a value]” or “greater than about [a value]” should be understood in view of the definition of the term “about” provided herein. The terms “about” and “approximately” may be used interchangeably.

As used herein, the verb “comprise” as is used in this description and in the claims and its conjugations are used in its non-limiting sense to mean that items following the word are included, but items not specifically mentioned are not excluded.

Throughout the specification the word “comprising,” or variations such as “comprises” or “comprising,” will be understood to imply the inclusion of a stated element, integer or step, or group of elements, integers, or steps, but not the exclusion of any other element, integer or step, or group of elements, integers, or steps. The present disclosure may suitably “comprise”, “consist of”, or “consist essentially of”, the steps, elements, and/or reagents described in the claims.

It is further noted that the claims may be drafted to exclude any optional element. As such, this statement is intended to serve as antecedent basis for use of such exclusive terminology as “solely”, “only”, and the like in connection with the recitation of claim elements, or the use of a “negative” limitation.

Unless defined otherwise, all technical and scientific terms used herein have the same meanings as commonly understood by one of ordinary skill in the art to which this disclosure belongs. Preferred methods, devices, and materials are described, although any methods and materials similar or equivalent to those described herein can be used in the practice or testing of the present disclosure. All references cited herein are incorporated by reference in their entirety.

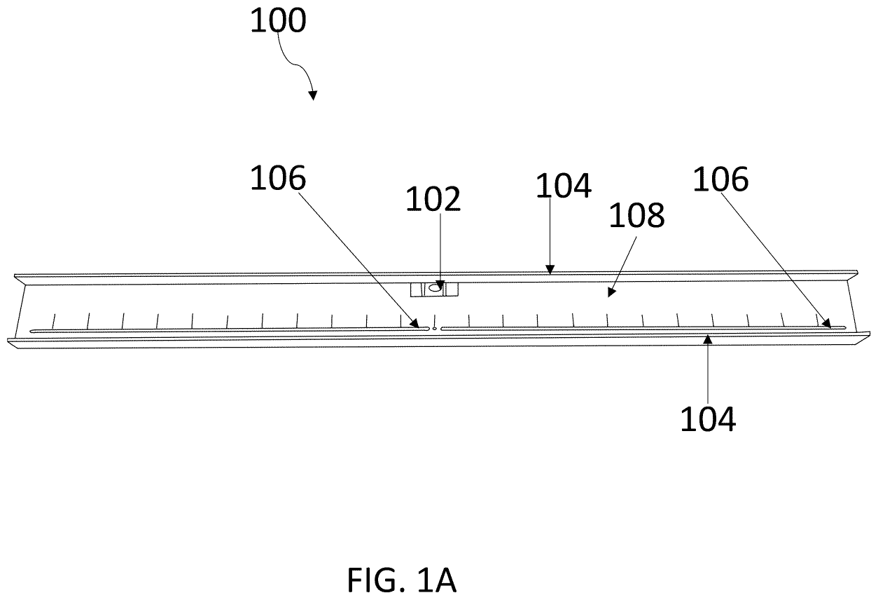

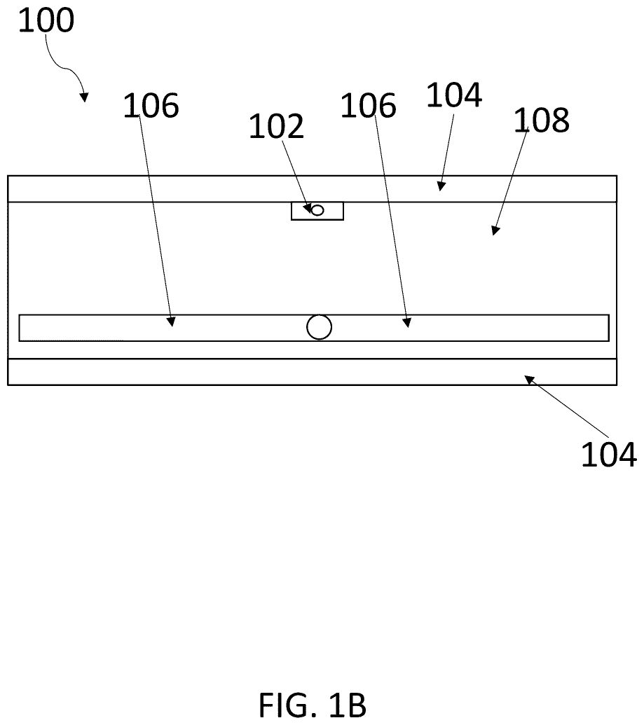

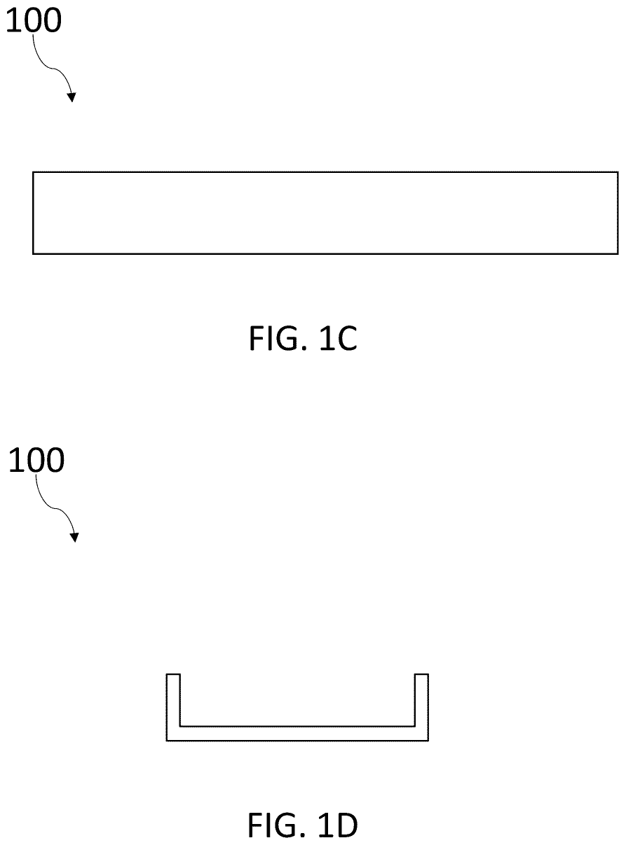

In at least one aspect of the present disclosure, a level is disclosed. As shown in FIGS. 1A-1D, the level can include a leveling component 102, a plurality of edges 104, at least one slit 106, and a writing surface 108. The leveling component 102 is designed to indicate whether the level 100 is entirely horizontal. The plurality of edges 104 enables the level to stand without an additional tool or device. The writing surface 108 is designed to receive a mark from a marking tool (e.g., writing utensil). The at least one slit 106 enables the marking tool to reach a hanging surface (e.g., wall). Advantageously, the writing surface allows for the removal (e.g., erasure) of marks, thereby enabling a user to reuse the level.

For example, and without limitation, the writing surface may include (1) a powdered-coated finish, (2) an anodized aluminum finish, (3) enamel, (4) epoxy, (5) an laminate film, (6) paint, (7) plastic (e.g., acrylonitrile butadiene styrene (ABS)), (8) tape, and/or other materials or finishes that enable application of a writing tool on the writing surface.

In some embodiments, the level enables (1) measuring distances for hanging articles, (2) drawing a straight line, (3) measuring a length of an object, (4) measuring a distance between objects, and (5) ensuring that objects are level (e.g., parallel to the ground or perpendicular to the ground). The level improves upon existing tools because of the at least one slit and the ability to make and erase a pencil mark directly with a pencil or similar writing utensil. The slit reduces the opportunity for error when hanging objects because the slit is designed with enough space to make a mark. The marking measurements enable a user to make marks to the nearest millimeter.

In some embodiments, a method of hanging an object is disclosed. First, a level is placed on or near at least two hanging points of interests of an object. For example, and without limitation, the hanging points of interests includes a slot to receive a nail. The level includes at least one leveling component, at least one slit, and a writing surface. The at least one leveling component is operable to detect and display whether the level is completely horizontal or vertical. Using a writing utensil or marking tool, a mark is made on the writing surface to indicate a position of each hanging point of interest. Next, the level is positioned on a hanging surface (e.g. wall). Once positioned on the hanging surface, a marking tool or writing utensil marks the hanging surface through the at least one slit. The at least one slit is positioned near the writing surface, thereby enabling a user to mark the hanging surface in one or more identical spots to the marks for the hanging points of interest. After the hanging surface is marked, the level is removed from the hanging surface and one or more attachment device (e.g., nail) is attached (e.g., inserted) to the hanging surface at each mark. Finally, the hanging object is positioned on the one or more attachment device.

In some embodiments, the level includes plastic, metal, composites, and/or a combination thereof. In some other embodiments, the level includes a second leveling component and a second slit in a vertical orientation. In some embodiments, the level includes a holder for a writing utensil/marking tool. In some embodiments, the level includes a writing utensil and/or marking tool. For example, and without limitation, the level includes a slidable marking tool operable to slide along a length and/or width of the level to mark a spot.

In some other embodiments, the level includes a visual marker. For example, and not limitation, the visual marker includes a laser. In some embodiments, the leveling tool includes a magnetic component to attach to a wall or another object or article. In some embodiments, the leveling tool includes at least one sensor. For example, and without limitation, the at least one sensor includes an imaging sensor (e.g., camera) and is operable to detect the presence and location of hanging components of an article. The leveling tool further includes an audio component designed to give audio cues to aid with placing an article on the wall.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

The descriptions of the various embodiments of the present disclosure have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A level comprising:
at least one leveling component;
a plurality of edges;
at least one slit; and
at least one writing surface;
wherein the at least one leveling component indicates a horizontal orientation of the level;
wherein the at least one slit provides access to a hanging surface;
wherein the at least one writing surface is operable to receive a mark from a writing utensil; and
wherein the writing surface is further operable for removal of the mark.

2. The level of claim 1, wherein the at least one leveling component includes at least two leveling components, wherein at least one leveling component of the at least two leveling components indicates a horizontal orientation of the level, wherein at least one leveling component of the at least two leveling components indicates a vertical orientation of the level.

3. The level of claim 1, wherein the at least one writing surface comprises a vertical writing surface and a horizontal writing surface.

4. The level of claim 1, wherein the writing utensil is slidably connected to the level.

5. The level of claim 1, wherein the writing surface and the at least one leveling component are positioned between the plurality of edges, wherein the plurality of edges runs along a top and a bottom of the level.

6. The level of claim 1, wherein each edge of the plurality of edges extends away from the at least one writing surface.

7. The level of claim 1 further comprising at least one visual identification tool, wherein the at least one visual identification tool includes a laser and/or a sensor.

8. The level of claim 1 further comprising at least one magnet, wherein, via the at least one magnet, the level is configured to attach to a wall or object.

9. The level of claim 1, wherein the writing surface includes at least one of an enamel, epoxy, laminate film, paint, plastic, or tape.

10. A level comprising:
a plurality of leveling components;
a plurality of edges;
a plurality of slits; and
at least one writing surface;
wherein the plurality of leveling components indicates an orientation of the level;
wherein the at least one writing surface is positioned between the plurality of edges;
wherein the plurality of slits is configured for at least a portion of a writing tool to pass through the plurality of slits; and
wherein the at least one writing surface is configured to receive a mark from a writing utensil.

11. The level of claim 10, wherein the plurality of leveling components includes a horizontal leveling component and a vertical leveling component, wherein the horizontal leveling component indicates a horizontal orientation of the level, wherein the vertical leveling component indicates a vertical orientation of the level.

12. The level of claim 10, wherein the plurality of edges runs along a top and a bottom of the level.

13. The level of claim 10 further comprising at least one visual identification tool, wherein the at least one visual identification tool includes a laser and/or a sensor.

14. The level of claim 10 further comprising at least one magnet, wherein, via the at least one magnet, the level is configured to attach to a wall or object.

15. The level of claim 10, wherein the at least one writing surface includes at least one of an enamel, epoxy, laminate film, paint, plastic, or tape.

16. A level comprising:
a plurality of leveling components;
a plurality of edges;
a plurality of slits; and
at least one writing surface;
wherein the plurality of leveling components includes a horizontal leveling component and a vertical leveling component, wherein the horizontal leveling component indicates a horizontal orientation of the level, wherein the vertical leveling component indicates a vertical orientation of the level;
wherein the at least one writing surface is positioned between the plurality of edges;
wherein each edge of the plurality of edges extends away from the at least one writing surface;
wherein the plurality of slits is configured for at least a portion of a writing tool to pass through the plurality of slits; and
wherein the at least one writing surface is configured to receive a mark from a writing utensil.

17. The level of claim 16, wherein the plurality of slits includes at least two slits.

18. The level of claim 16, wherein the writing utensil is slidably connected to the level.

19. The level of claim 16, wherein the at least one writing surface is further configured for removal of the mark from the writing utensil.

20. The level of claim 16, further comprising at least one visual identification tool, wherein the at least one visual identification tool includes a laser and/or a sensor.
